(19) United States
(12) Patent Application Publication
(10) Pub. No.: US 2011/0254308 A1
(43) Pub. Date: Oct. 20, 2011

(54) Removable vehicle sun shield

(76) Inventor: Carol Ann Hingst, Hackettstown, NJ (US)

(21) Appl. No.: 12/931,171

(22) Filed: Jan. 27, 2011

Related U.S. Application Data
(60) Provisional application No. 61/340,437, filed on Mar. 18, 2010.

(51) Int. Cl. B60J 3/00

(52) U.S. Cl. 296/97.6

(57) ABSTRACT

This sun shield FIG. 1-A1 is a one piece flat, flexible, colorless, opaque plastic material, with one strip of sticky back hook and loop tape FIG. 1 on the left side FIG. 1-A2 and the right side FIG. 1-A3. The right side FIG. 1A-3 is brought to the Left side FIG. 1-A2 pressed together to form a seam FIG. 2-C therefore creating a cylinder FIG. 2-D.

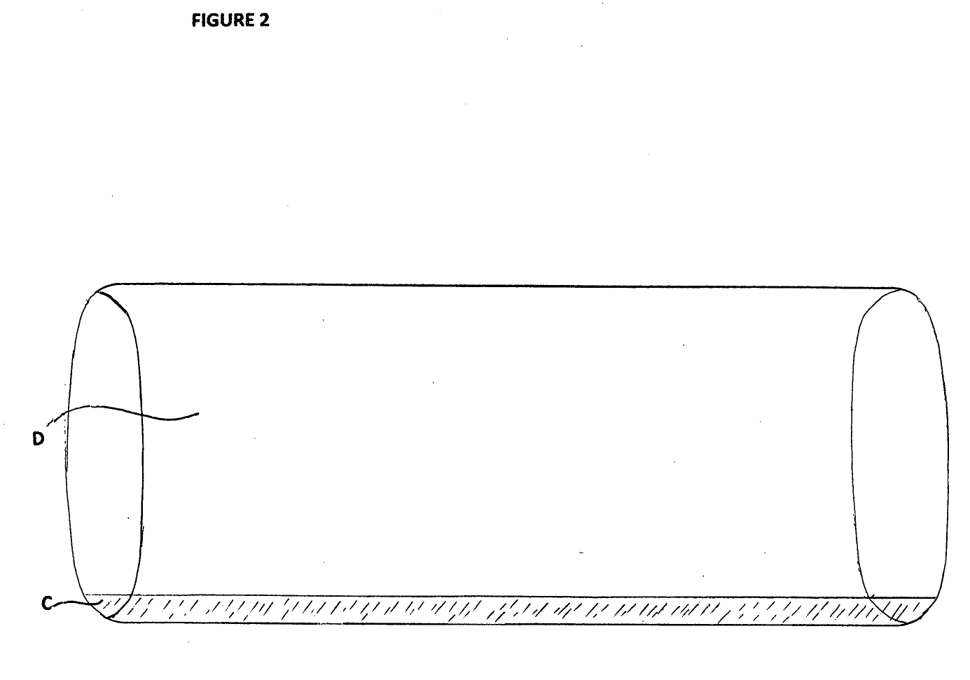

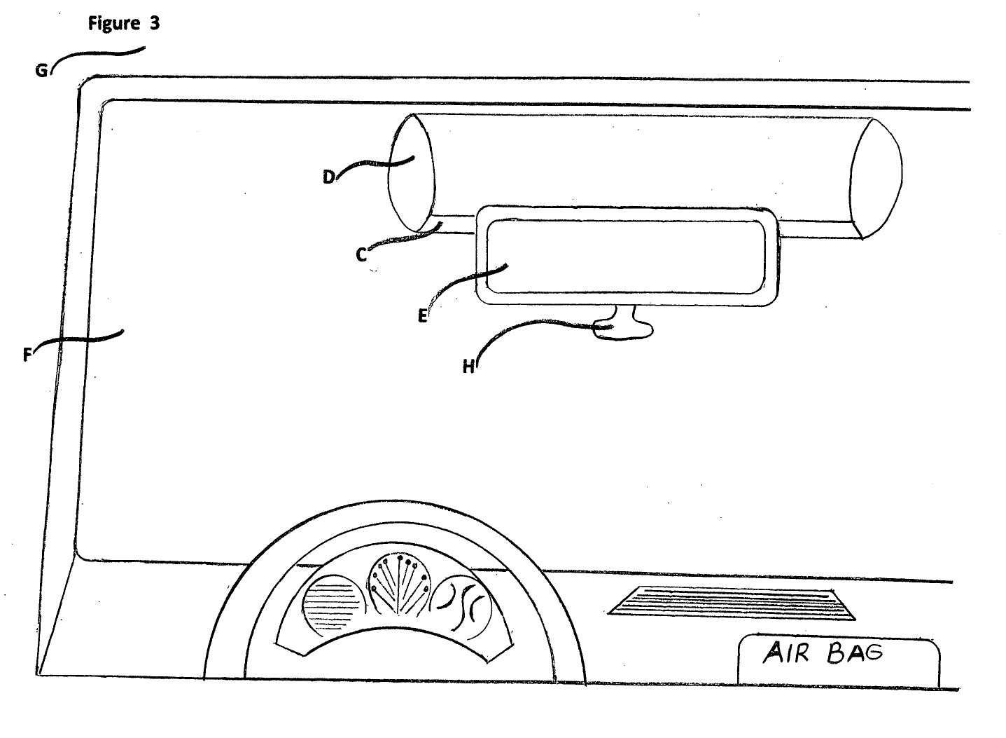

The cylinder FIG. 2-D is mountable and removable without any attachments what so ever. The cylinder FIG. 2-D creates a natural resistance when placed behind the rearview mirror FIG. 3-E and the interior of the windshield FIG. 3-F stays in place resting on the rearview mount FIG. 3-H when the vehicle is in motion. This sun shield adds to the protection from sun glare coming in between the ceiling of the vehicle FIG. 3-G and the rearview mirror FIG. 3-E.

This invention is inexpensive, convenient and offers protection from sun glare for the driver and passengers of the vehicle.

References cited U.S. Patent Documents

| | | | |
|---|---|---|---|
| 3,107,829 | October 1963 | Makowski | 222/525 |
| 3,276,640 | October 1966 | Kessler | 222/546X |
| 3,338,293 | August 1967 | Hohmann | 160/368 |
| 3,442,476 | May 1969 | Trimble | 248/205X |
| 3,649,069 | March 1972 | Zip | 248/205.9 |

### BACKGROUND OF THE INVENTION

This invention is unique for use when the vehicle is in motion and is for interior use only and relates to a device to shade the section of the wind shield between the ceiling FIG. 3-G and the rearview mirror FIG. 3 E.

The terms “sun screen”, “sunshield” and “sunshade” are equivalent and have the same meaning.

Vehicular sun screens are for use when the vehicle is not in use covering the entire windshield and or the rear window.

This invention blocks out the sun coming in between the ceiling FIG. 3-G and the rearview mirror FIG. 3-E of the vehicle when in motion.

### SUMMARY

The vehicle sun shield was invented to block the sun glare that comes in between the rear view mirror and the roof of the vehicle.

The vehicle sun shield will benefit all motorists; it is inexpensive, convenient and offers protection from sun glare while driving for motorists and passengers.

There are sun screens in use when the vehicle in not in use covering the entire windshield. The vehicle sun shield is a colorless opaque plastic sheet that conforms into a small hand held flexible cylinder. The unique feature of the vehicle sun shield is that there are no attachments what so ever.

The vehicle sun shield easily slides into place behind the rear view mirror resting on the rear view mount.

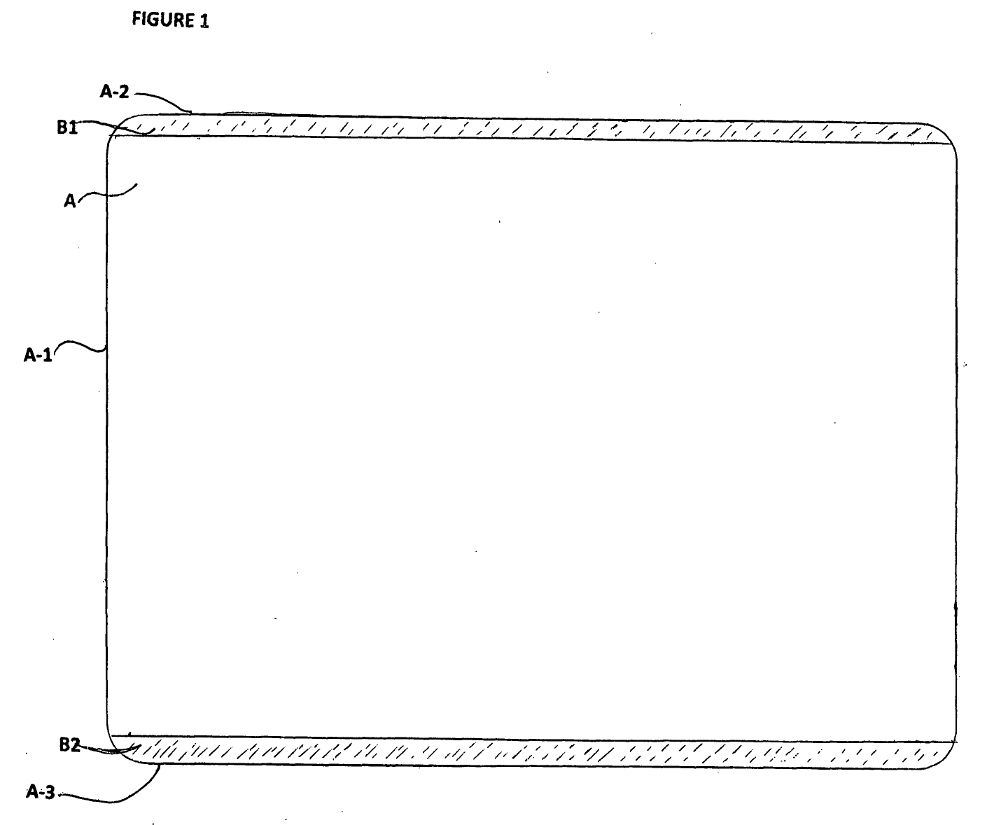

Referring to the drawings FIG. 1-A is a flat one piece of colorless opaque sheet of plastic material measuring 11¾″ wide FIG. 1-B1 by 9½″ High FIG. 1-A1.

FIG. 1-B1 and B2 are two ½″ High by 11¾″ Wide hook and loop strips. One strip is affixed on the left side FIG. 1-A2 the second strip is affixed to the right side FIG. 1-A3.

FIG. 2—By bringing the sides FIG. 1-B1 and B2 together press into place forming a seam FIG. 2-C.

FIG. 2-D is now a cylinder measuring 11¾″ Wide×3″ in Diameter with no attachments.

### DETAILED DESCRIPTION OF THE INVENTION

This invention is used for vehicle interior sun glare protection between the ceiling FIG. 3-G and the rearview mirror FIG. 3-E.

The sun shield with the seam FIG. 3-C facing downward slides behind the rearview mirror FIG. 3-E and rests on the mirror mount FIG. 3-H.

Note: There are changes on one drawing the windshield, FIG. 3

1. This vehicle sun shield is unique to all vehicle sun shields available to the public. The vehicle sun shield easy and convenient for motorists to use and is intended for use when the vehicle is in motion and conforms into a hand held flexible cylinder without any attachments what so-ever that slides behind the vehicle's rear view resting on the rear view mirror mount. The circumference of the flexible cylinder is larger than the distance from the back of the rear view mirror and the inside of the windshield that it presses against, causing a natural resistance of pressure that keeps the vehicle sun shield in place with any attachments what so-ever.
